(19) United States
(12) Patent Application Publication
(10) Pub. No.: US 2008/0025233 A1
(43) Pub. Date: Jan. 31, 2008

(54) COMMUNICATION APPARATUS STORAGE MEDIUM STORING PROGRAM EXECUTED BY COMMUNICATION APPARATUS AND NETWORK FORMING METHOD

(75) Inventor: Mitsuru Otsuka, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/780,046

(22) Filed: Jul. 19, 2007

(30) Foreign Application Priority Data
Jul. 31, 2006 (JP) 2006-208498

(51) Int. Cl. H04Q 7/00

(52) U.S. Cl. 370/254; 370/338

(57) ABSTRACT

A communication apparatus including a determining device that determines a distance between the communication apparatus and a first managing device in a first network and a forming device that forms a second network in which the communication apparatus or another communication apparatus operates as a second managing device, where formation of the second network is based on the determination of the distance between the communication apparatus and the first managing device.

### BACKGROUND OF THE INVENTION

1. Field of the Invention

The present invention relates to a communication apparatus, a storage medium storing a program to control a communication apparatus, and a network forming method.

2. Description of the Related Art

Wireless LAN standards corresponding to the IEEE 802.11 standards include an infrastructure mode in which stations (STAs) capable of communicating with one another under management of an access point (AP), and an ad-hoc mode in which the STAs communicate with one another without management of the AP.

In wireless radio communication, as the distance between communication partners increases, the environment for radio waves deteriorates and a throughput decreases because the intensity of the ratio wave reduces and an error rate increases. Accordingly, various methods capable of realizing communication even in the deteriorated state of the environment for the radio waves have been proposed.

One technique for switching over the infrastructure mode and the ad-hoc mode includes starting communication in the infrastructure mode and switching over the communication to the ad-hoc mode when an environment allows the STAs to communicate with one another without intervention of the AP (see US Patent Application No. 2004063458A (corresponding to Japanese Patent Laid-Open No. 2004-128785)).

Another known technique includes intercepting ACK sent back from the STA at the transmission destination to the AP, and switching over the communication from the infrastructure mode to an inter-terminal direct communication mode when it is determined that the reception intensity of radio waves carrying the ACK is not lower than a certain level and is satisfactory (see Japanese Patent Laid-Open No. 2005-323150).

Also, there is known a technique of selecting the AP, to which is connected the STA, depending on the electric field intensity and the communication quality of a signal transmitted from the AP to the STA (see Japanese Patent Laid-Open No. 2005-244721).

Further, there is known a technique of determining, based on the reception intensity of an electric field between a wireless communication apparatus and a base station, that the wireless communication apparatus is outside a communication area, and causing a wireless communication apparatus, which is a communication partner, to take a role of relay to the base station when the former wireless communication apparatus moves out of the communication area of the base station (see Japanese Patent Laid-Open No. 2005-341300).

As described above, the wireless LAN standards include the infrastructure mode and the ad-hoc mode. Some apparatuses adapted for the wireless LAN standards, are not adapted for the ad-hoc mode. The ad-hoc mode includes many points not clearly specified in the standards, and in some cases, even apparatuses adapted for the ad-hoc mode cannot establish communication between themselves. Further, in the ad-hoc mode, because there is no managing station, it is difficult to manage power save control.

In addition, the absence of the managing station in the ad-hoc mode causes a difficulty in security management and control, such as exchange and management of an encryption key, and a security level is usually lower in the ad-hoc mode as compared with the infrastructure mode. Due to the problems mentioned above, communication in the infrastructure mode is typically performed more often than in the ad-hoc mode.

When communication is switched over to the ad-hoc mode or the inter-terminal direct communication mode, as in US Patent Application No. 2004063458A (corresponding to Japanese Patent Laid-Open No. 2004-128785) or Japanese Patent Laid-Open No. 2005-323150, the above-described problems occur with the ad-hoc mode.

Japanese Patent Laid-Open No. 2005-244721 proposes the technique of selecting the AP which becomes the communication partner, and this proposed technique is not adapted for communication in an area where there is no AP.

With the technique proposed in Japanese Patent Laid-Open No. 2005-341300, the function of a relay station has to be newly introduced in addition to the base station. Accordingly, the base station is required to perform management of both the relay station and the wireless communication apparatus. This results in more complicated management.

### SUMMARY OF THE INVENTION

The present invention enables a communication apparatus to operate as a managing device while forming a new network depending on change of the communication environment, thus realizing communication with higher efficiency.

According to one aspect, the present invention provides a communication apparatus including a determining device configured to determine a distance between the communication apparatus and a first managing device in a first network, and a forming device configured to, based on a result of the determining device, form a second network in which either the communication apparatus or another communication apparatus functions as a second managing device.

According to another aspect, the present invention provides a communication apparatus including a requesting device configured to, upon receiving a network setting request from another communication apparatus while the communication apparatus participates in a first network managed by a first managing device, request a communication partner to set a network, and a forming device configured to, based on a response from the communication partner in reply to the request from the requesting device, effectuate a function as a second managing device and form a second network while continuing participation in the first network.

Further features of the present invention will become apparent from the following description of exemplary embodiments with reference to the attached drawings.

### BRIEF DESCRIPTION OF THE DRAWINGS

FIG. 1 is a block diagram of a communication system according to an exemplary embodiment of the present invention.

FIG. 2 is a block diagram of a communication apparatus according to the exemplary embodiment of the present invention.

FIG. 3 is a block diagram of the communication apparatus according to the exemplary embodiment of the present invention.

FIG. 4 is a sequence chart executed according to the exemplary embodiment of the present invention when a STA 101 operates as an access point and forms a group together with a STA 102.

FIG. 5 is a sequence chart executed according to the exemplary embodiment of the present invention when the STA 101 stops the operation in an AP mode and both the STA 101 and the STA 102 associate in a terminal mode with an AP 104 again.

FIG. 6 is a sequence chart executed according to the exemplary embodiment of the present invention when the STA 102 rejects group setting requested by the STA 101.

FIG. 7 is a sequence chart executed according to the exemplary embodiment of the present invention when the STA 102 rejects the group setting requested by the STA 101.

FIG. 8 is a sequence chart executed according to the exemplary embodiment of the present invention when the STA 101 stops the operation in the AP mode and both the STA 101 and a STA 103 associate in the terminal mode with the AP 104 again.

FIG. 9 is a sequence chart executed according to the exemplary embodiment of the present invention when the STA 101 requests the group setting during data communication between the STA 102 and the STA 103 which are in association with the AP 104.

FIG. 10 is a sequence chart executed according to the exemplary embodiment of the present invention when the STA 102 stops the operation in the AP mode and the STA 101, the STA 102 and the STA 103 associate in the terminal mode with the AP 104 again.

FIG. 11 is a sequence chart executed according to the exemplary embodiment of the present invention when the STA 101 requests the group setting during data communication between the STA 102 and the STA 103 which are in association with the AP 104.

FIG. 12 is a sequence chart executed according to the exemplary embodiment of the present invention when the STA 102 stops the operation in the AP mode and the STA 101 associates with the AP 104 again.

FIG. 13 is a flowchart illustrating an operation of the STA 101 according to the exemplary embodiment of the present invention.

FIG. 14 is a flowchart illustrating an operation of the STA 102 according to the exemplary embodiment of the present invention.

FIG. 15 is a flowchart illustrating an under-communication process in the operation of the STA 102 according to the exemplary embodiment of the present invention.

FIG. 16 is a flowchart illustrating an independent process in the operation of the STA 102 according to the exemplary embodiment of the present invention.

FIG. 17 is a sequence chart illustrating an operation according to the exemplary embodiment of the present invention when a communication system constitutes a wireless network.

FIG. 18 illustrates one example of a display provided on a user interface according to the present invention when a group setting request is received.

### DESCRIPTION OF THE EMBODIMENTS

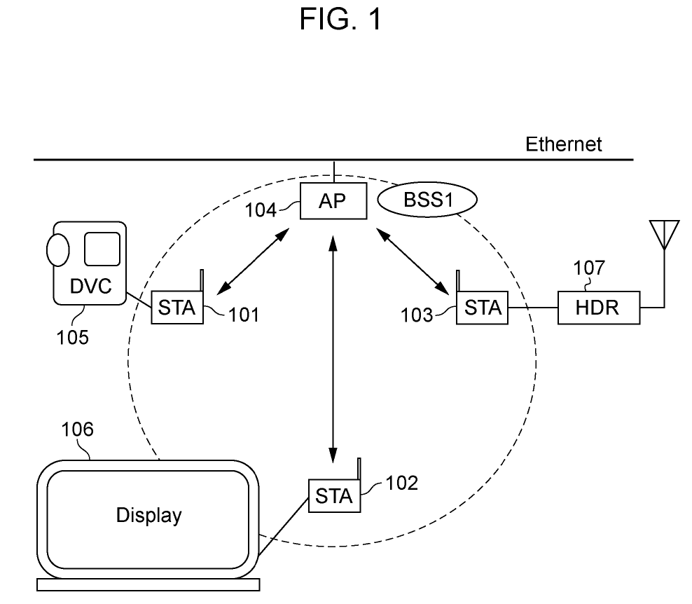

FIG. 1 illustrates a network constructed by communication apparatuses according to an exemplary embodiment of the present invention. An access point (hereinafter abbreviated as an “AP”) in a wireless LAN, described below, is a managing device that has a function of constructing a wireless network and managing the wireless network in accordance with the specifications defined in IEEE Std 802.11-1999 (R2003). The AP periodically transmits “Beacon” for providing management information of the wireless network to a station (hereinafter abbreviated as a “STA”). The STA is a managed device that obtains the management information of the wireless network constructed by the AP upon receiving “Beacon”, participates in the wireless network, and performs communication under the management of the AP.

The wireless LAN communication network of FIG. 1 includes a communication apparatus 101 (hereinafter abbreviated as a “STA 101”), a communication apparatus 102 (hereinafter abbreviated as a “STA 102”), a communication apparatus 103 (hereinafter abbreviated as a “STA 103”), and an access point apparatus 104 (hereinafter abbreviated as an “AP 104”). An identifier of the network managed by the AP 104 is presumed to be BSS1. Each STA is connected to an image input device or an image output device and operates as a communication adaptor for providing a wireless LAN communication function.

In the example illustrated in FIG. 1, the STA 101 is connected to a digital video camera (DVC) 105 and provides a wireless LAN communication function. The STA 102 is connected to a display 106 and provides a wireless LAN communication function. The STA 103 is connected to a hard disk recorder (HDR) 107 and provides a wireless LAN communication function. While each STA operates as a communication adaptor in FIG. 1, the STA can also operate, as illustrated in FIG. 3, by incorporating the wireless LAN communication function in the image input device or the image output device.

FIG. 1 illustrates a state in which the STA 101, the STA 102 and the STA 103 are each connected in an infrastructure mode to the AP 104 and are capable of communicating with one another via the AP 104.

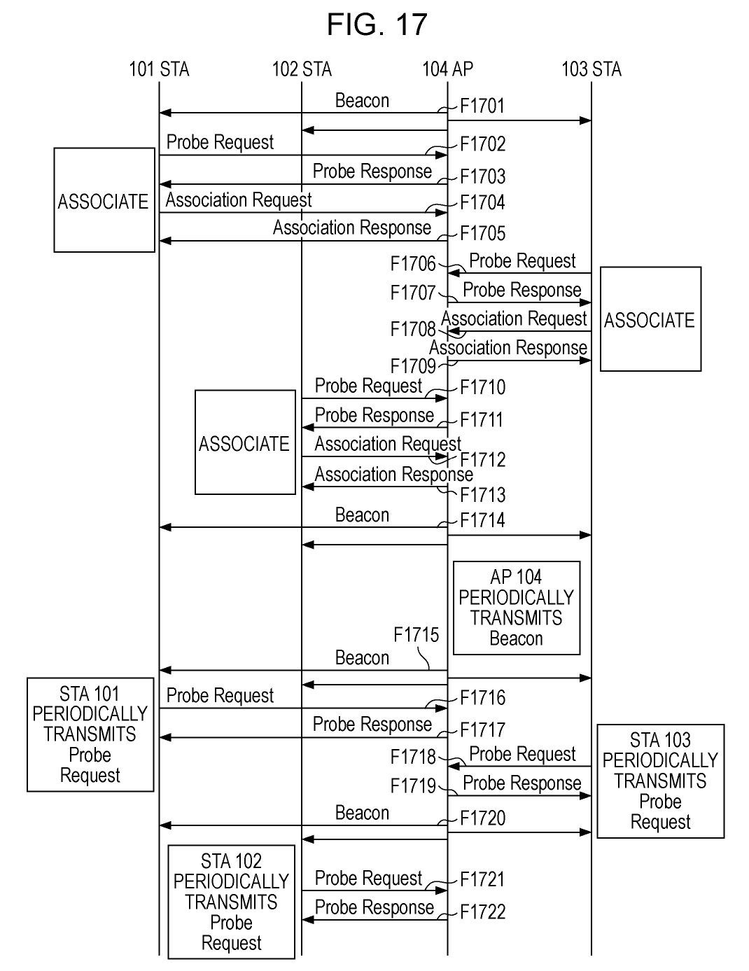

FIG. 17 is a sequence chart for an operation according to the exemplary embodiment when each STA comes into the state communicable via the AP 104.

The AP 104 transmits “Beacon” to the STA 101 (F1701). Upon receiving “Beacon”, the STA 101 transmits “Probe Request” to the AP 104 for confirming the presence of the network constructed by the AP 104 (F1702). Upon receiving “Probe Request”, the AP 104 transmits “Probe Response” to the STA 101 to provide various items of information regarding the network constructed by the AP 104 (F1703). Thereafter, the STA 101 transmits “Association Request” to the AP 104 to request connection to the AP 104 (F1704). The AP 104 responds by transmitting “Association Response” to the STA 101 to indicate whether the connection to the STA 101 is admitted (F1705). If the connection is admitted, the association between the STA 101 and the AP 104 is completed and the STA 101 is brought into the state communicable via the AP 104.

The STA 102 and the STA 103 also operate in the same manner as the STA 101 and are each brought into the state communicable via the AP 104. Details of formats of the messages transmitted and received in the associating operation sequence are described in the IEEE 802.11 standards. In the following, therefore, a description of details of the associating operation sequence is omitted.

The notification of “Beacon” from the AP 104 is periodically performed at certain time intervals (F1714, F1715, and F1720). After the completion of the association between each STA and the AP 104, each STA periodically transmits “Probe Request” to the AP 104 at intervals of the certain time so that the AP 104 can manage the STA (F1716, F1718, and F1721). Upon receiving “Probe Request”, the AP 104 sends back “Probe Response” (F1717, F1719, and F1722).

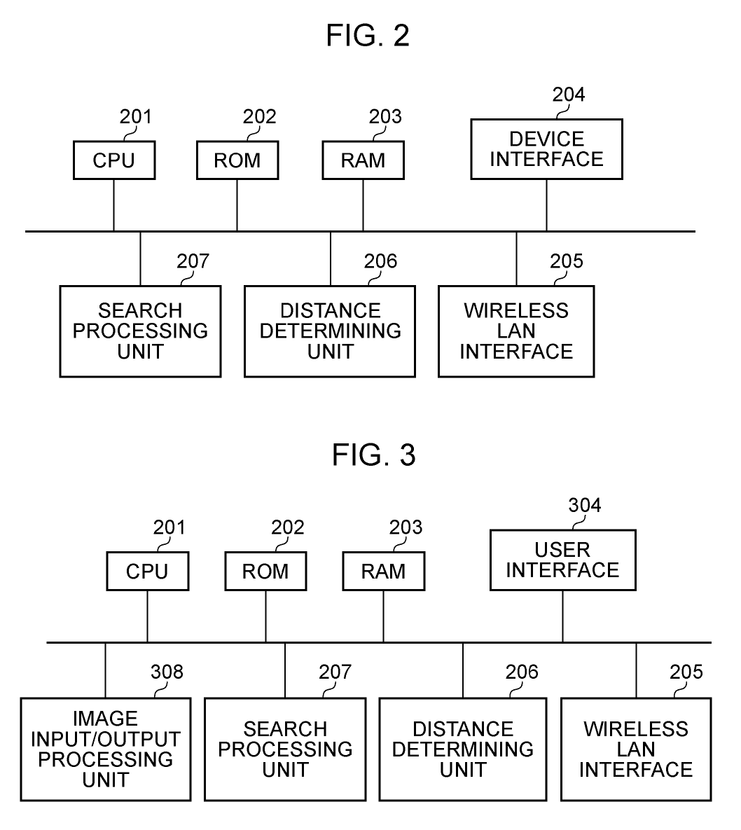

FIGS. 2 and 3 are each a block diagram of the communication apparatus according to the exemplary embodiment.

FIG. 2 illustrates the configuration of an STA. A CPU 201 controls the entire STA in accordance with control programs stored in a ROM 202 or a RAM 203. Note that the processing of the STA described below is performed by the CPU 201 executing various kinds of processing in accordance with the control programs stored in the ROM 202 or the RAM 203. The ROM 202 and the RAM 203 store control data executed by the CPU 201. Further, the RAM 203 is utilized as a work area for the CPU 201.

A device interface 204 serves as a unit interface for connection to the image input device or the image output device. A wireless LAN interface 205 provides the wireless LAN communication function for performing wireless LAN communication in conformity with IEEE 802.11. A distance determining unit 206 measures a distance between the relevant STA and the AP or another STA in a communication state, and determines whether the network configuration is to be changed. A search processing unit 207 searches for the location of another STA within a wireless communication area by receiving a signal transmitted from the other STA.

The measurement of the distance between the relevant STA and the AP or another STA in the communication state by the distance determining unit 206 is performed based on the intensity of radio waves received from the AP or the other STA. Thus, it is determined that as the radio wave intensity increases, the distance is shorter and the radio wave intensity decreases, the distance is longer. Also, by comparing the intensities of the radio waves received from two communication apparatuses, the apparatus providing the stronger intensity of the radio waves is determined to be located at a nearer position.

While the present invention is described here, by way of example, in connection with the radio wave intensity, the distance measurement can also be performed based on an error rate of a received signal. In the case using the error rate, it is determined that as the error rate decreases, the distance is shorter and the error rate increases, the distance is longer. Also, by comparing the error rates of received data from two communication apparatuses, the apparatus providing the smaller error rate is determined to be located at a nearer position.

As an alternative, when various kinds of signals are transmitted, each signal can be transmitted with addition of a transmission power value. In such a case, the attenuation rate of a signal is obtained from both a power value (radio wave intensity) received on the reception side and the transmission power value contained in the received signal, and the distance measurement is performed based on a value of the attenuation rate. Furthermore, the distance can also be determined by synthetically utilizing the results of distance measurements made by a plurality of methods.

FIG. 3 illustrates an example in which the STA does not operate as a communication adaptor and the wireless LAN communication function is incorporated in the image input device or the image output device. A CPU 201, a ROM 202, a RAM 203, a wireless LAN interface 205, a distance determining unit 206, and a search processing unit 207 are the same as those described above with respect to FIG. 2, respectively, and a description thereof is not repeated here. A user interface 304 provides display and operating functions to a user. An image input/output device processing unit 308 provides an image input or output function.

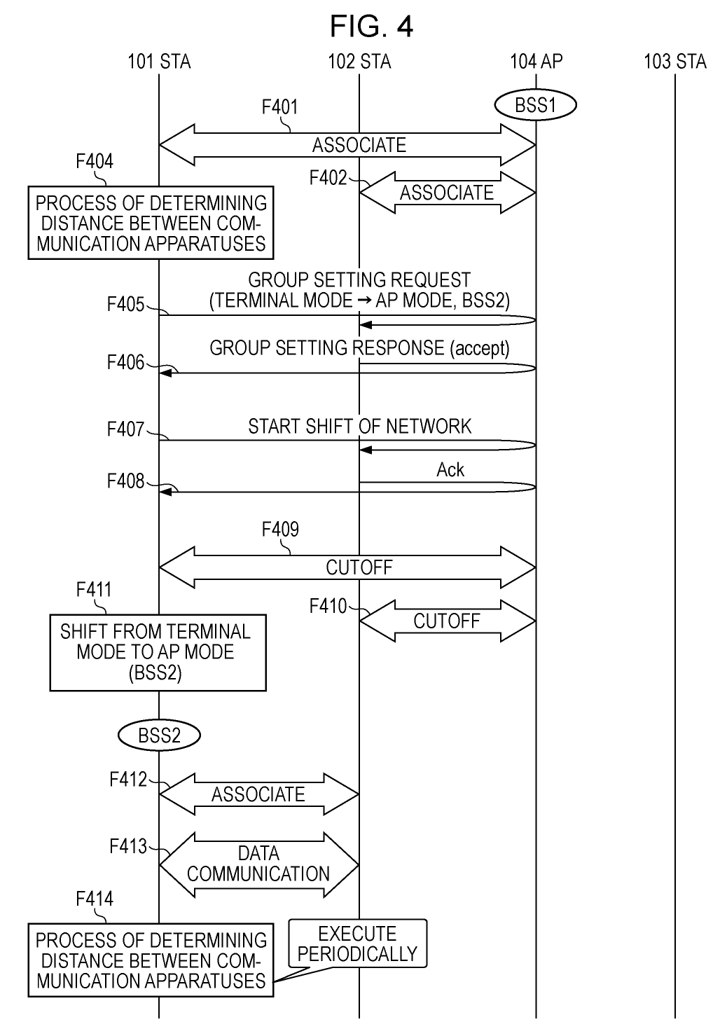

FIG. 4 is a sequence chart executed when the STA 101 operates as the access point and forms a group together with the STA 102.

Referring to FIG. 4, the STA 101 associates with the AP 104 (F401). Also, the STA 102 associates with the AP 104 (F402). As a result, the STA 101 and the STA 102 are able to communicate via the AP 104. Although the STA 102 starts data communication after determining whether the communication is to be started, the following description is made on an assumption that the STA 102 does not start the data communication.

The STA 101 executes a process of determining a distance between the communication apparatuses (F404) by the distance determining unit 206. The process of determining the distance between the communication apparatuses (F404) is executed by receiving “Beacon” which is periodically transmitted from the AP 104, and by intercepting “Probe Request” which is periodically transmitted from another STA. Alternatively, the STA 101 can also determine the distance from itself to the AP 104 by intercepting “Probe Response” which is transmitted from the AP 104.

The distance determining unit 206 of the STA 101 determines whether the communication state between the STA 101 and the AP 104 is degrading and the distance between them increasing from the viewpoint of the wireless communication state. When the STA 101 can intercept “Probe Request” from another STA, the STA 101 further determines the distance from itself to the other STA. Based on the distance measurements, the STA 101 determines whether the communication state between the STA 101 and the other STA is better than that between the STA 101 and the AP 104 and the other STA is located at a shorter distance than the AP 104 from the viewpoint of the wireless communication state.

The CPU 201 receives the determination result from the distance determining unit 206 and makes a determination to execute group setting if the determination indicates that the distance between the STA 101 and the AP 104 is increased or that the other STA is moved to a position nearer to the STA 101 than the AP 104 and is now located at a shorter distance than the AP 104.

In this case, the distance determining unit 206 of the STA 101 determines that the communication state between the STA 101 and the AP 104 is degrading and the distance between them is increasing from the viewpoint of the wireless communication state. Further, the distance determining unit 206 determines that the communication state between the STA 101 and the STA 102 is better than that between the STA 101 the AP 104 and the distance between the STA 101 and the STA 102 is shorter than that between the STA 101 and the AP 104 from the viewpoint of the wireless communication state. Accordingly, the STA 101 makes a determination to execute the group setting (described below).

When the group setting is executed, the STA 101 transmits a group setting request to the STA 102 via the AP 104 (F405). The group setting request notifies not only a shift to an access point mode (AP mode) for construction of a new network, but also an identifier of the constructed network. Herein, the AP mode means that the relevant communication apparatus operates as the access point. While the group setting request can also notify additional information regarding the new network, such as a frequency channel for construction of the network and an encryption method and an encryption key which are used in the constructed network, that information is omitted in the following description for the sake of simplicity. In the example of FIG. 4, it is requested that the STA 101 shifts to the AP mode and constructs a network with an identifier BSS2. Upon receiving the group setting request, the STA 102 determines whether it is under communication with some other STA.

If the STA 102 is under communication with some other STA, the STA 102 executes an under-communication process (described below). Herein, because the STA 102 is not under communication with some other STA, the STA 102 executes an independent process based on the determination that the STA 102 is not under communication with some other STA. In the independent process, the STA 102 determines whether it accepts the group setting request, and sends back the determination result as a group setting response.

For example, when the STA 102 receives the group setting request while it is not under communication with some other STA, the STA 102 displays on the user interface that it has received the group setting request from another communication apparatus (STA). Whether to allow the group setting request or not is determined depending on an input made, through the user interface, by the user who has checked the displayed request.

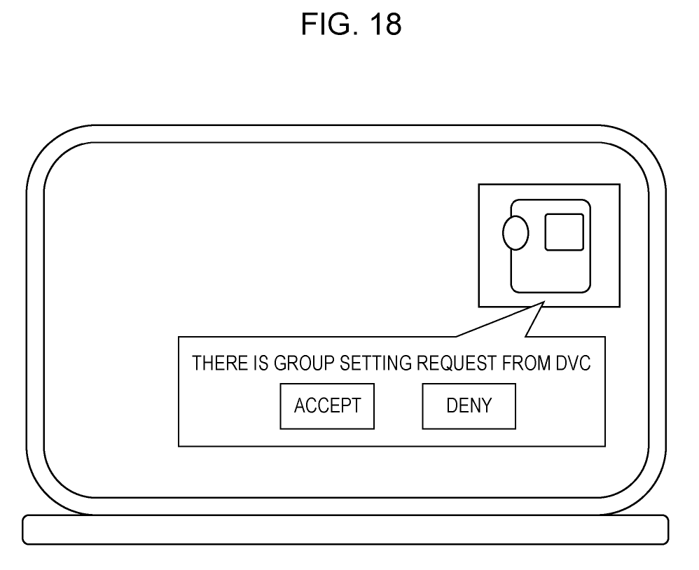

FIG. 18 illustrates one example of the above-mentioned display indicating that the group setting request has been issued from the DVC 105 of the STA 101 to the display of the STA 102. By employing the user interface, the user designates whether the group setting is allowed. In the case accepting the group setting request, the STA 102 sends back a group setting response (accept) to the STA 101. In the case denying the group setting request, the STA 102 sends back a group setting response (deny) to the STA 101. In FIG. 4, the STA 102 accepts the group setting request and sends back the group setting response (accept) to the STA 101. Correspondingly, the STA 101 receives the group setting response from the STA 102 (F406).

Upon receiving the group setting response (accept), the STA 101 transmits a network-shift start message to the STA 102 via the AP 104 (F407). The STA 102 receives the network-shift start message from the STA 101 and sends back “Ack” to the STA 101. By receiving “Ack” from the STA 102 (F408), the STA 101 detects that the network-shift start message has been accepted by the STA 102.

When the network-shift start message is accepted by the STA 102, the STA 101 cuts off the connection with the AP 104 (F409) and shifts from the terminal mode to the AP mode for constructing the network with the identifier BSS2 (F411). Similarly, the STA 102 cuts off the connection with the AP 104 (F410) upon receiving the network-shift start message. Further, the STA 102 operates in the terminal mode and associates with the STA 101 operating in the AP mode (F412).

In response to the association from the STA 102 (F412), the STA 101 is connected to the STA 102. When the network shift is completed, the STA 101 and the STA 102 are able to perform communication in the infrastructure mode in which the STA 101 functions as the AP. Thus, when the network constructed by the STA 101 operating in the AP mode is used for data communication, the data communication is performed between the STA 101 and the STA 102 (F413). The STA 101 operating in the AP mode periodically executes the process of determining the distance between the communication apparatuses (F414) by the distance determining unit 206.

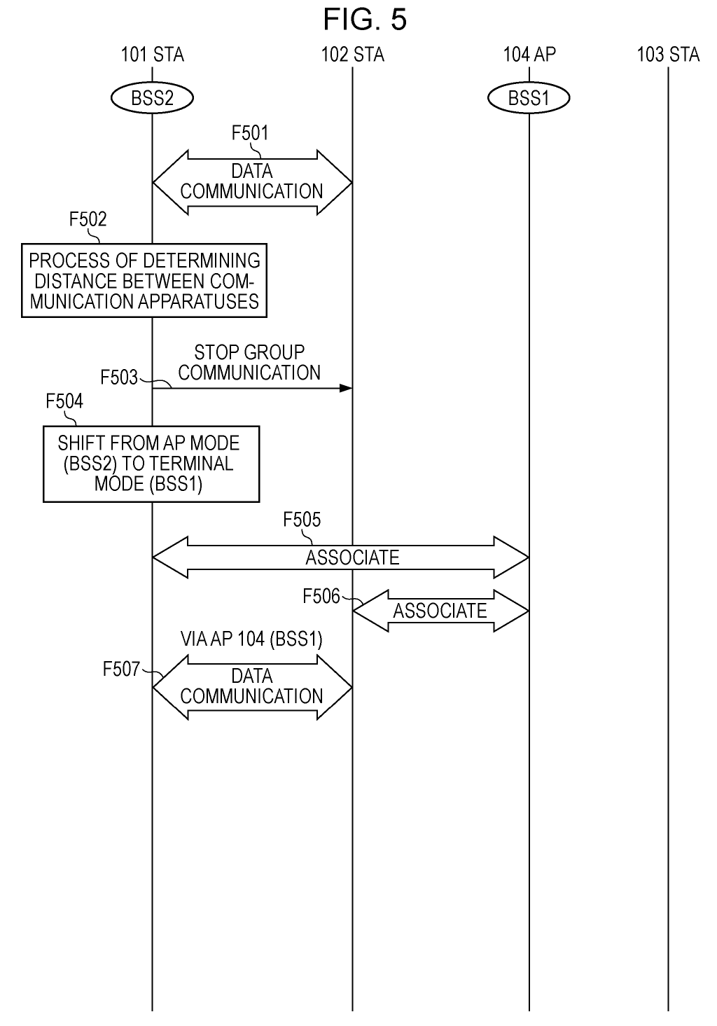

FIG. 5 is a sequence chart executed when, after the processing of FIG. 4, the STA 101 stops the operation in the AP mode and both the STA 101 and the STA 102 associate in the terminal mode with the AP 104 again.

Referring to FIG. 5, even while operating in the AP mode, the STA 101 periodically executes the process of determining the distance between the communication apparatuses (F502). The distance determining process is similarly executed (F502) even during the data communication (F501) between the STA 101 and the STA 102. Based on the result of the distance determining process, the STA 101 determines whether the operation in the AP mode is to be stopped to stop the communication based on the group setting.

When the result of the distance determining process indicates that, from the viewpoint of the wireless communication state, the distance between the STA 101 and the AP 104 is shorter than the distance between the STA 101 and the STA 102 for which the group setting has been requested, the communication based on the group setting is determined to be stopped. When the communication based on the group setting is stopped, the STA 101 transmits a message instructing stop of the group communication to the STA 102 (F503). In addition, the STA 101 stops the communication with the STA 102, shifts from the AP mode to the terminal mode (F504), and associates with the AP 104 (F505). Thereafter, the data communication is performed via the AP 104 (F507).

Upon receiving the message instructing stop of the group communication (F503), the STA 102 stops the data communication with the STA 101 to which the STA 102 is connected based on the group setting, and cuts off the connection with the STA 101 operating in the AP mode. Further, the STA 102 associates with the AP 104 (F506). Thereafter, the data communication is performed via the AP 104 (F507).

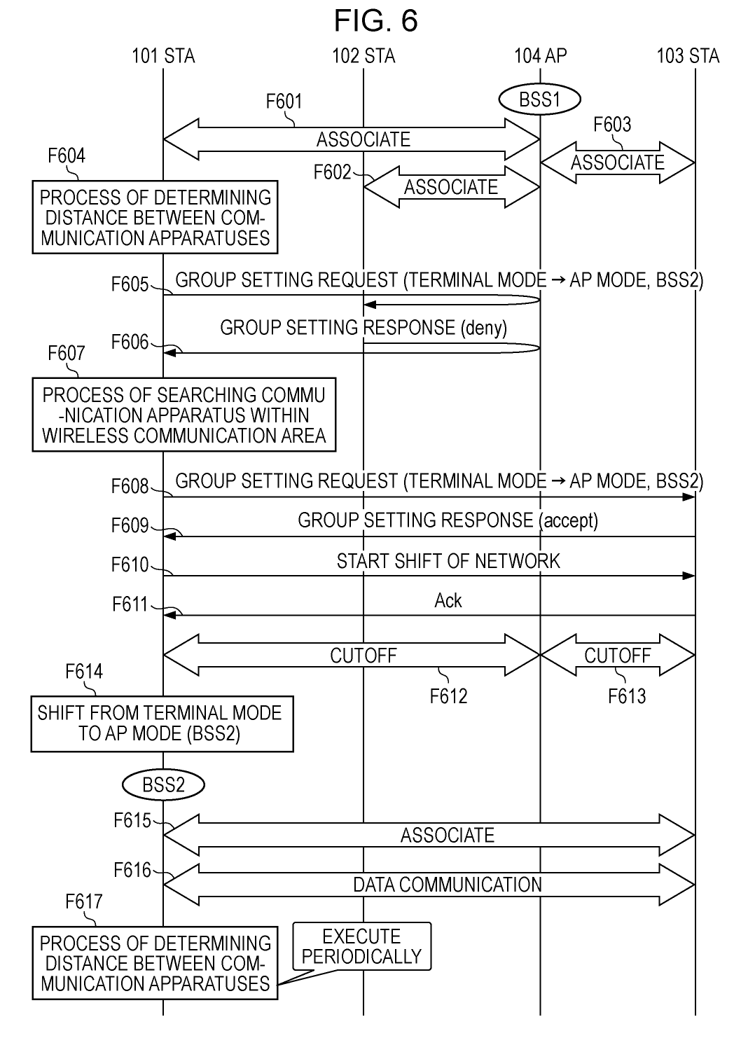

FIG. 6 is a sequence chart executed when the STA 102 rejects the group setting requested by the STA 101.

Referring to FIG. 6, the STA 101 associates with the AP 104 (F601). Also, the STA 102 and the STA 103 associate with the AP 104 (F602 and F603). As a result, the STA 101, the STA 102 and the STA 103 are able to communicate with one another via the AP 104. Although the STA 101, the STA 102 and the STA 103 start data communication after determining whether the communication is to be started, FIG. 6 illustrates the case in which the data communication is not started.

The STA 101 having associated with the AP 104 periodically executes a process of determining a distance between the communication apparatuses (F604) by the distance determining unit 206. The process of determining the distance between the communication apparatuses is executed by receiving “Beacon” which is periodically transmitted from the AP 104, and by intercepting “Probe Request” which is periodically transmitted from another STA. Alternatively, the STA 101 can also determine the distance from itself to the AP 104 by intercepting “Probe Response” which is transmitted from the AP 104.

The distance determining unit 206 of the STA 101 determines whether the communication state between the STA 101 and the AP 104 is becoming worse and the distance between them is increasing from the viewpoint of the wireless communication state. When the STA 101 can intercept “Probe Request” from another STA, the STA 101 further determines the distance from itself to the other STA. Based on the distance measurements, the STA 101 determines whether the communication state between the STA 101 and the other STA is better than that between the STA 101 and the AP 104 and the other STA is located at a shorter distance than the AP 104 from the viewpoint of the wireless communication state. The STA 101 executes group setting if the determination result of the distance determining unit 206 indicates that the distance between the STA 101 and the AP 104 is increased or that the other STA is moved to a position nearer to the STA 101 than the AP 104 and is now located at a shorter distance than the AP 104.

In this case, the distance determining unit 206 determines that the communication state between the STA 101 and the STA 102 is better than that between the STA 101 the AP 104 and the distance between the STA 101 and the STA 102 is shorter than that between the STA 101 and the AP 104 from the viewpoint of the wireless communication state. Accordingly, the STA 101 determines to execute the group setting.

When the group setting is executed, the STA 101 transmits a group setting request to the STA 102 via the AP 104 (F605). The group setting request represents such a request that the STA 101 shifts from the terminal mode to the AP mode and constructs a network with an identifier BSS2.

Upon receiving the group setting request, the STA 102 determines whether it is under communication with some other STA. If the STA 102 is under communication with some other STA, the STA 102 executes an under-communication process, as described below. Herein, because the STA 102 is not under communication with some other STA, the STA 102 executes an independent process based on the determination that the STA 102 is not under communication with some other STA.

In the independent process, the STA 102 determines whether it accepts the group setting request, and sends back the determination result as a group setting response. For example, the STA 102 displays on the user interface that it has received the group setting request from the STA 101. Whether to allow the group setting request or not is determined depending on an input made, through the user interface, by the user who has checked the displayed request. FIG. 18 illustrates one example of the above-mentioned display indicating that the group setting request has been issued from the DVC 105 of the STA 101 to the display of the STA 102. By employing the user interface, the user designates whether the group setting is allowed.

The following description is of the case where the STA 102 denies the group setting request. In the case denying the group setting request, the STA 102 sends back a group setting response (deny) to the STA 101 (F606). The STA 101 receives the group setting response (deny) transmitted from the STA 102 (F606).

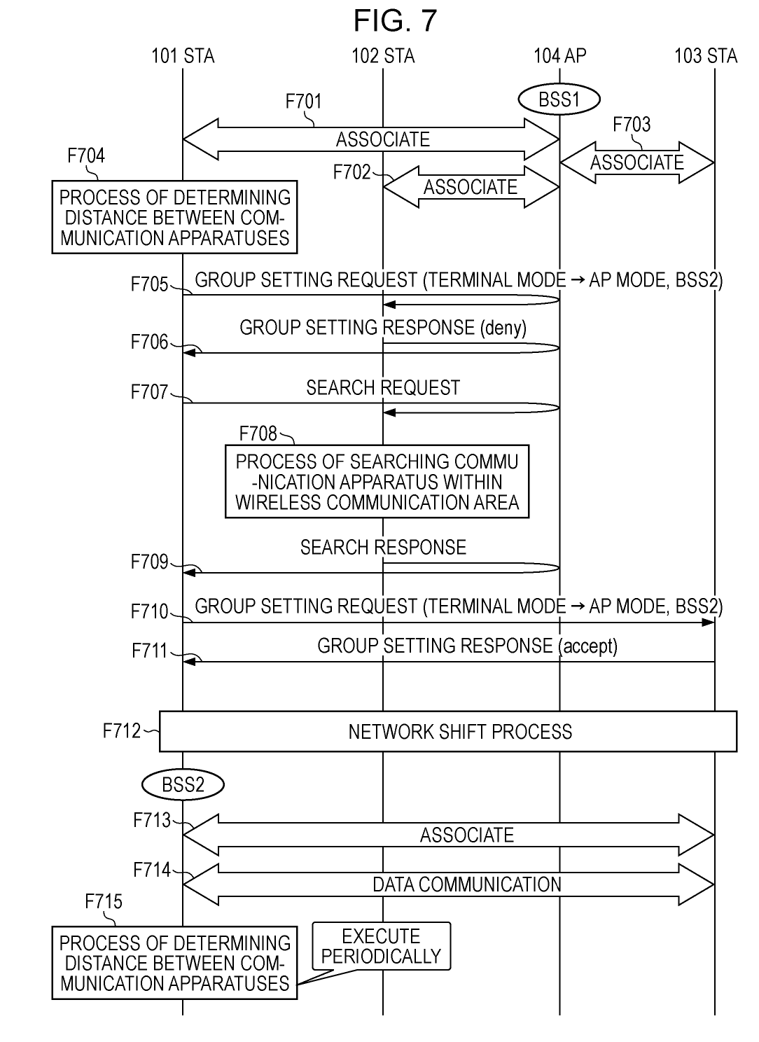

When the STA 101 receives the group setting response (deny), a search process of searching for another STA connected to the AP 104 is executed (F607). The search process is executed by the STA 101 or the STA 102, the latter executing the search process in response to a request issued from the STA 101 to the STA 102. FIG. 6 illustrates the case where the search process is executed by the STA 101, and FIG. 7 illustrates the case where the search process is executed by the STA 102.

The search process is executed by receiving a signal transmitted from another STA. In practice, the search process is executed by intercepting “Probe Request” periodically transmitted from another STA which is in association with the AP 104, and by determining whether the other STA is located nearby.

Note that since F701, F702, F703, F704, F705 and F706 in the sequence chart of FIG. 7 are similar to F601, F602, F603, F604, F605 and F606 respectively in the sequence chart of FIG. 6, a description thereof is not repeated here. Referring to FIG. 7, when the search process is executed by the STA 102, the STA 101 transmits a communication apparatus search request to the STA 102 via the AP 104 (F707). After executing the search process (F708), the STA 102 transmits, as a search response, the search result to the STA 101 (F709). The STA 101 receives the search response from the STA 102 (F709).

In the following description, it is assumed that the STA 103 is detected in the search process as a communication apparatus which is located within a wireless communication area. When the search process is executed by the STA 102 as in FIG. 7, the detection of the STA 103 is notified in the search response.

If no STA is found as the communication apparatus within the wireless communication area in the search process, the search process is determined to have failed, and the group setting sequence is brought to an end.

If the search process has succeeded, the group setting is executed. More specifically, if the search process has succeeded, the STA 101 transmits a group setting request to the STA 103 via the AP 104 (F608 and F710). The group setting request represents such a request that the STA 101 shifts from the terminal mode to the AP mode and constructs a network with an identifier BSS2.

When the STA 103 receives the group setting request, the STA 103 displays on the user interface that it has received the group setting request from the STA 101. Whether to allow the group setting request is determined depending on an input made by the user through the user interface. FIG. 18 illustrates one example of the above-mentioned display indicating that the group setting request has been issued from the DVC 105 of the STA 101 to the display of the STA 103. By employing the user interface, the user designates whether the group setting is allowed.

In the case accepting the group setting request, the STA 103 sends back a group setting response (accept) indicating acceptance of the group setting request to the STA 101 (F609 and F711). In the case denying the group setting request, the STA 103 sends back a group setting response (deny) indicating rejection of the group setting request to the STA 101. In the denying case, if other STA than the STA 103 is found in the search process, the STA 101 transmits the group setting request to the other STA. If no other STA is found in the search process, the group setting sequence is brought to an end.

Upon receiving the group setting response (accept) (F609 and F711), the STA 101 transmits a network-shift start message to the STA 103 (F610). The STA 103 receives the network-shift start message from the STA 101 and sends back “Ack” to the STA 101 (F611). By receiving “Ack” in response to the network-shift start message from the STA 103 (F611), the STA 101 detects that the network-shift start message has been accepted by the STA 103.

When the network-shift start message is accepted by the STA 103, the STA 101 cuts off the connection with the AP 104 (F612) and shifts from the terminal mode to the AP mode for constructing the network with the identifier BSS2 (F614). On the other hand, after transmitting “Ack”, the STA 103 cuts off the connection with the AP 104 (F613) and associates with the STA 101 operating in the AP mode (F615 and F713).

In response to the association from the STA 103, the STA 101 is connected to the STA 103 (F615 and F713). When the network constructed by the STA 101 operating in the AP mode is used for data communication, the data communication is started between the STA 101 and the STA 103 (F616 and F714) in the infrastructure mode in which the STA 101 functions as the AP. A network shift process (F712) in FIG. 7 corresponds to a sequence represented by F610, F611, F612, F613, and F614 in FIG. 6.

Thereafter, the STA 101 having shifted to the network based on the group setting periodically executes the process of determining the distance between the communication apparatuses (F617 and F715).

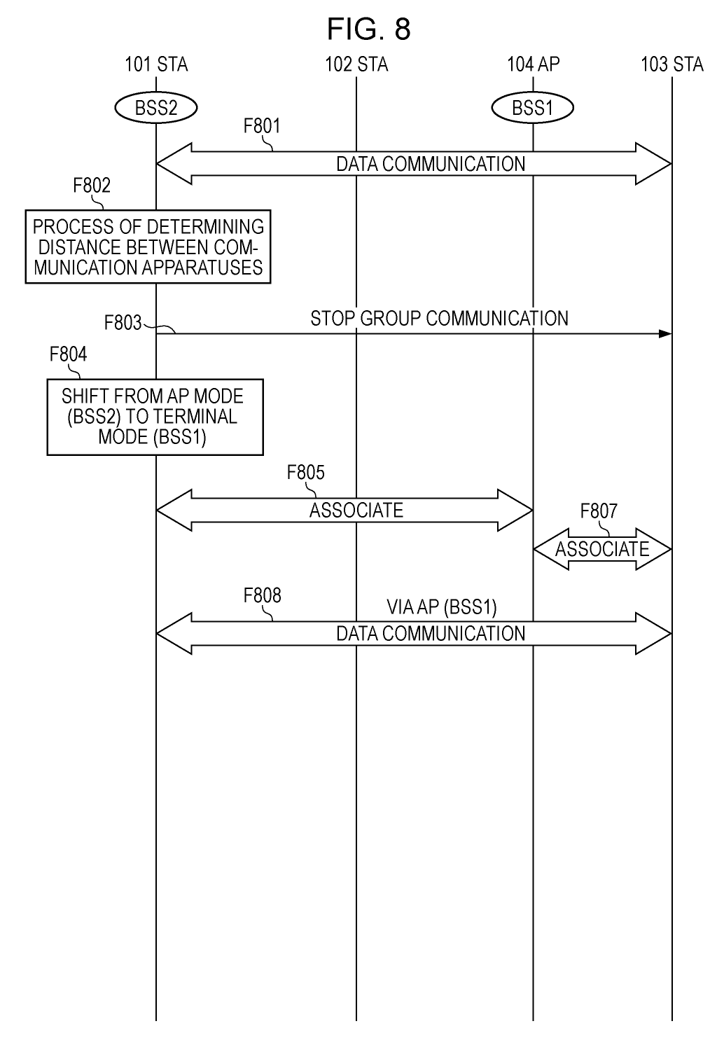

FIG. 8 is a sequence chart executed when, after the processing of FIG. 7, the STA 101 stops the operation in the AP mode and both the STA 101 and the STA 103 associate in the terminal mode with the AP 104 again.

Even while operating in the AP mode, the STA 101 periodically executes the process of determining the distance between the communication apparatuses (F802). The distance determining process is similarly executed even during the data communication (F801) between the STA 101 operating in the AP mode and the STA 103.

Based on the result of the distance determining process, the STA 101 determines whether the operation in the AP mode is to be stopped to stop the communication based on the group setting. When the result of the distance determining process indicates that, from the viewpoint of the wireless communication state, the distance between the STA 101 and the AP 104 is shorter than the distance between the STA 101 and the STA 103 for which the group setting has been requested, the communication based on the group setting is determined to be stopped.

When the communication based on the group setting is stopped, the STA 101 transmits a message instructing stop of the group communication to the STA 103 (F803). In addition, the STA 101 stops the communication with the STA 103, shifts from the AP mode to the terminal mode (F804), and associates with the AP 104 (F805). Thereafter, the data communication is performed via the AP 104 (F808).

Upon receiving the message instructing stop of the group communication (F803), the STA 103 stops the data communication with the STA 101 to which the STA 103 is connected based on the group setting, and associates with the AP 104 (F807). Thereafter, the data communication is performed via the AP 104 (F808).

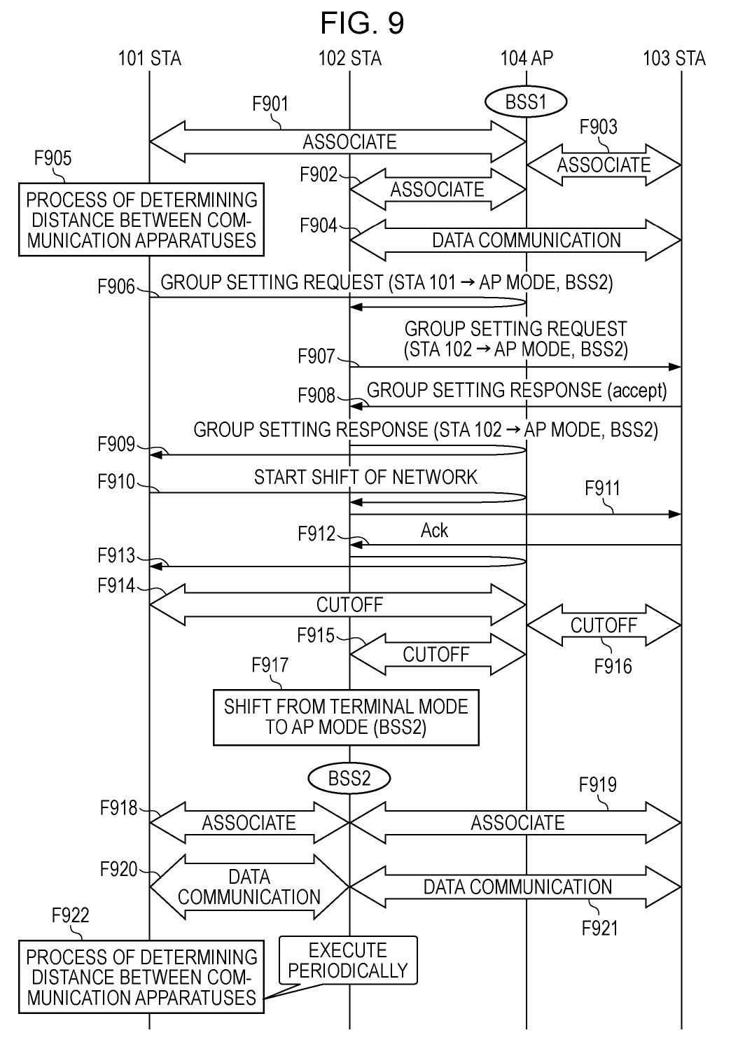

FIG. 9 is a sequence chart executed when the STA 101 requests the group setting during data communication between the STA 102 and the STA 103 which are in association with the AP 104.

Referring to FIG. 9, the STA 101 associates with the AP 104 (F901). Also, the STA 102 and the STA 103 associate with the AP 104 (F902 and F903). As a result, the STA 101, the STA 102 and the STA 103 are able to communicate with each other via the AP 104. Each of those STAs starts data communication after determining whether the communication is to be started. The following description is made on an assumption that the STA 102 and the STA 103 start the data communication (F904).

The STA 101 having associated with the AP 104 executes, as described above, a process of determining a distance between the communication apparatuses (F905) by the distance determining unit 206. Herein, with the process of determining the distance between the communication apparatuses, the STA 101 determines that the distance between the STA 101 and the STA 102 is shorter than that between the STA 101 and the AP 104.

When the group setting is executed, the STA 101 transmits a group setting request to the STA 102 via the AP 104 (F906). The group setting request represents such a request that the STA 101 shifts to the AP mode and constructs a network with an identifier BSS2.

Upon receiving the group setting request, the STA 102 determines whether it is under communication with some other STA. Herein, the STA 102 is communicating with the STA 103. Therefore, the STA 102 executes an under-communication process. In the under-communication process, the STA 102 transmits a group setting request to the counterpart of the data communication (i.e., the STA 103) for requesting a shift to the AP mode and construction of a network with an identifier BSS2 (F907). In other words, the group setting request represents such a request that the STA 102 shifts to the AP mode and constructs the network with the identifier BSS2.

Upon receiving the group setting request (F907), the STA 103 determines whether it accepts the group setting request. In the case accepting the group setting request, the STA 103 sends back a group setting response (accept) to the STA 102. In the case denying the group setting request, the STA 103 sends back a group setting response (deny) to the STA 102. Herein, it is assumed that since the STA 103 is not communicating with the other STA than the STA 102, the STA 103 accepts the group setting request and sends back the group setting response (accept) to the STA 102 (F908). As an alternative, whether to accept the group setting request can be determined with selection made by the user in a similar manner to that described above.

When the group setting request is accepted by the STA 103, the STA 102 transmits, to the STA 101, a group setting response for notifying that the STA 102 shifts to the AP mode and constructs the network with the identifier BSS2 (F909).

Upon receiving the group setting response (F909), the STA 101 transmits a network-shift start message to the STA 102 (F910). When the STA 102 receives the network-shift start message (F910), it also transmits the network-shift start message to the STA 103 (F911). The STA 103 receives the network-shift start message from the STA 102 (F911) and sends back Ack to the STA 102 (F912). When the STA 102 receives “Ack” from the STA 103 (F912), it sends back “Ack” to the STA 101 (F913).

Upon receiving “Ack” (F913), the STA 101 cuts off the connection with the AP 104 (F914) and associates with the STA 102 operating in the AP mode (F918). Also, when the STA 102 performs the data communication via the network constructed in the AP mode, the STA 101 performs the data communication with the STA 102 (F920). The data communication is performed in the infrastructure mode in which the STA 102 functions as the AP.

After transmitting “Ack” (F913), the STA 102 cuts off the connection with the AP 104 (F915), shifts from the terminal mode to the AP mode, and constructs the network with the identifier BSS2 (F917). Thereafter, the STA 102 accepts the association from the STA 101 and the STA 103 (F918 and F919) and is connected to the STA 101 and the STA 103. Since the STA 102 is under the data communication with the STA 103, the STA 102 continues the data communication with the STA 103 (F921) even after coming into the operation in the AP mode.

The data communication between the STA 102 and the STA 103 is also performed in the infrastructure mode in which the STA 102 functions as the AP. Further, when the STA 102 performs the data communication with the STA 101, the data communication with the STA 101 is started in the infrastructure mode in which the STA 102 functions as the AP (F920).

After transmitting “Ack” (F912), the STA 103 cuts off the connection with the AP 104 (F916). Further, the STA 103 associates with the STA 102 operating in the AP mode (F919) and continues the data communication with the STA 102 (F921). The STA 101 having shifted to the network based on the group setting periodically executes the distance determining process (F922) by the distance determining unit 206.

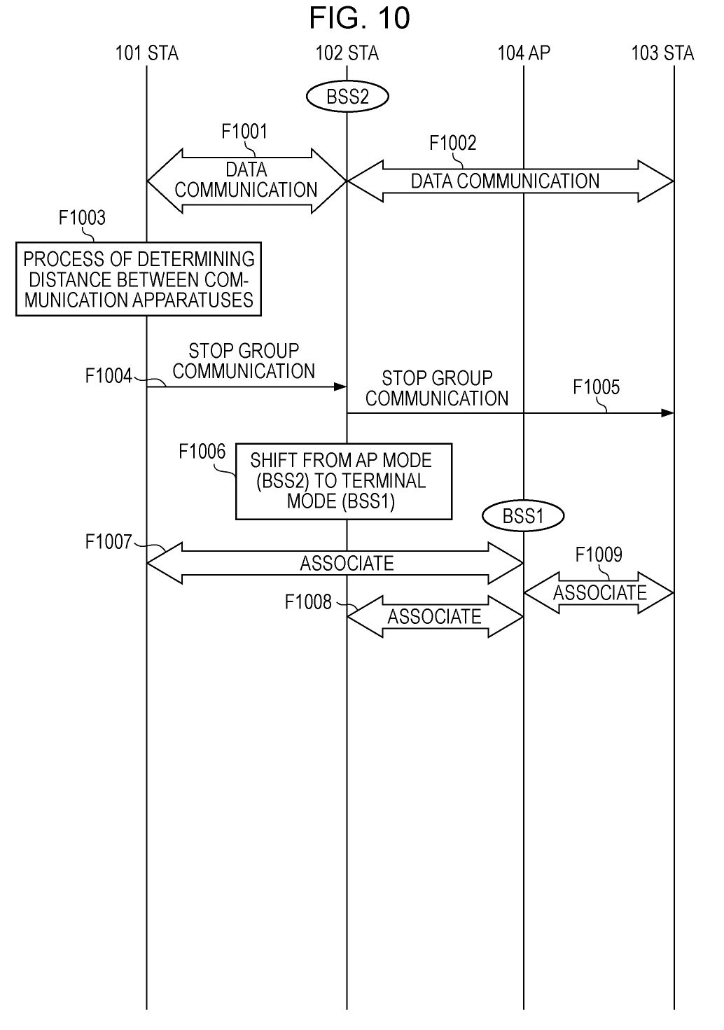

FIG. 10 is a sequence chart executed when, after the processing of FIG. 9, the STA 102 stops the operation in the AP mode and the STA 101, the STA 102 and the STA 103 associate in the terminal mode with the AP 104 again.

Even while associating with the STA 102 which is operating in the AP mode, the STA 101 periodically executes the process of determining the distance between the communication apparatuses (F1003) by the distance determining unit 206. The distance determining process is similarly executed even during the data communication (F1001) between the STA 101 and the STA 102. In the case of FIG. 10, the STA 102 further performs the data communication (F1002) with the STA 103.

Based on the result of the distance determining process executed by the distance determining unit 206 of the STA 101, the STA 101 determines whether the operation of the STA 102 in the AP mode is to be stopped to stop the communication based on the group setting. When the result of the distance determining process indicates that, from the viewpoint of the wireless communication state, the distance between the STA 101 and the AP 104 is shorter than the distance between the STA 101 and the STA 102 for which the group setting has been requested, the communication based on the group setting is determined to be stopped.

When the communication based on the group setting is stopped, the STA 101 transmits a message instructing stop of the group communication to the STA 102 (F1004). Thereafter, the STA 101 cuts off the connection with the STA 102 and associates with the AP 104 (F1007).

Upon receiving the message instructing stop of the group communication from the STA 101, the STA 102 transmits the message instructing stop of the group communication to the STA 103 which is in association with the STA 102 (F1005). After transmitting the message instructing stop of the group communication, the STA 102 cuts off the connection with each of the STA 101 and the STA 103. Further, the STA 102 stops the operation in the AP mode, shifts to the terminal mode (F1006), and associates with the AP 104 (F1008).

Upon receiving the message instructing stop of the group communication from the STA 102 (F1005), the STA 103 cuts off the connection with the STA 102 and associates with the AP 104 (F1009).

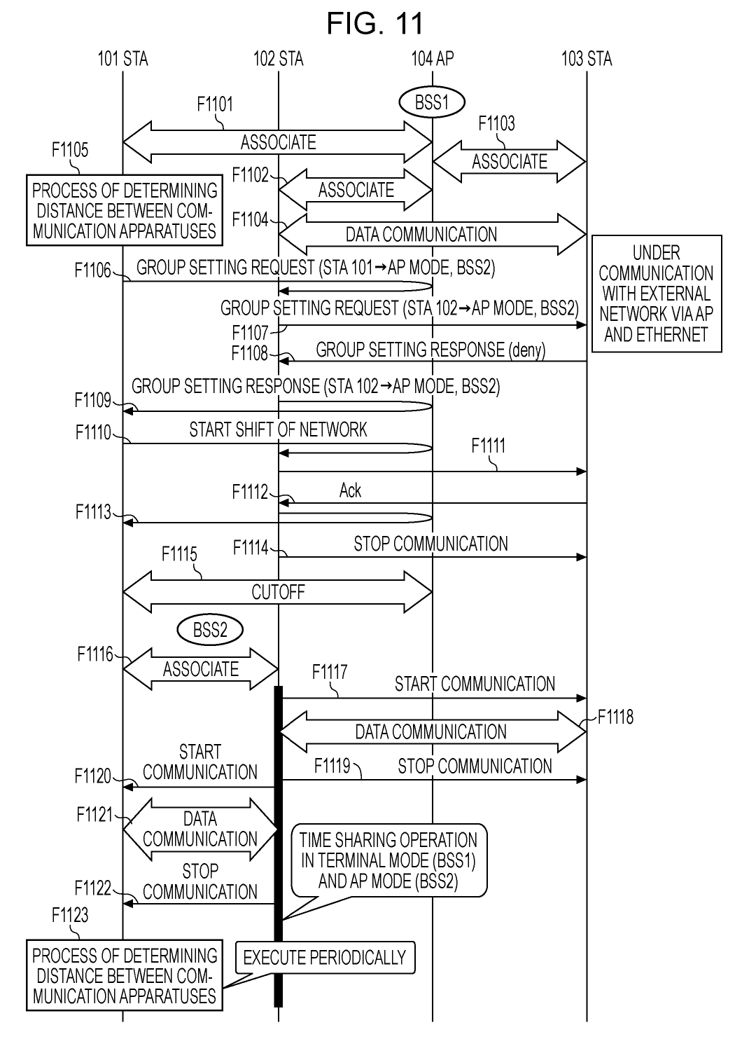

FIG. 11 is a sequence chart executed when the STA 101 requests the group setting during data communication between the STA 102 and the STA 103 which are in association with the AP 104.

Referring to FIG. 11, the STA 101 associates with the AP 104 (F1101). Also, the STA 102 and the STA 103 associate with the AP 104 (F1102 and F1103). As a result, the STA 101, the STA 102 and the STA 103 come into a state communicable via the AP 104.

Each of those STAs starts data communication after determining whether the communication is to be started. The following description is made on an assumption that the STA 102 and the STA 103 start the data communication (F1104). In addition to starting the data communication with the STA 102, the STA 103 further performs communication with an external network via the AP 104 and Ethernet. For example, the HDR 107 to which the STA 103 is connected performs communication of image data with the display 106 to which the STA 102 is connected, while the HDR 107 downloads broadcast program data from the external network.

The STA 101 having associated with the AP 104 executes, as described above, a process of determining a distance between the communication apparatuses (F1105) by the distance determining unit 206. Herein, with the process of determining the distance between the communication apparatuses, the STA 101 determines that the distance between the STA 101 and the STA 102 is shorter than that between the STA 101 and the AP 104.

When the group setting is executed, the STA 101 transmits a group setting request to the STA 102 via the AP 104 (F1106). The group setting request represents such a request that the STA 101 shifts to the AP mode and constructs a network with an identifier BSS2.

Upon receiving the group setting request, the STA 102 determines whether it is under communication with some other STA. Herein, the STA 102 is communicating with the STA 103. Therefore, the STA 102 executes an under-communication process. In the under-communication process, the STA 102 transmits a group setting request to the counterpart of the data communication (i.e., the STA 103) for requesting a shift to the AP mode and construction of a network with an identifier BSS2 (F1107). In other words, the group setting request represents such a request that the STA 102 shifts to the AP mode and constructs the network with the identifier BSS2.

Upon receiving the group setting request (F1107), the STA 103 determines whether it accepts the group setting request. As described above with reference to FIG. 9, in the case accepting the group setting request, the STA 103 sends back a group setting response (accept) to the STA 102. Herein, since the STA 103 is communicating with the external network via the AP mode 104, the STA 103 determines that it denies the group setting request. In order to deny the group setting request, the STA 103 sends back a group setting response (deny) to the STA 102 (F1108).

When the STA 102 receives the group setting response (deny) from the STA 103 (F1108), the STA 102 determines that the group setting request (F1107) has been denied. Based on the determination that the group setting request (F1107) has been denied by the STA 103, the STA 102 transmits, to the STA 101, a group setting response for notifying that the STA 102 shifts to the AP mode and constructs the network with the identifier BSS2 (F1109).

Upon receiving the group setting response (F1109) from the STA 102, the STA 101 transmits a network-shift start message to the STA 102 (F1110). When the STA 102 receives the network-shift start message from the STA 101, it also transmits the network-shift start message to the STA 103 (F1111).

The STA 103 receives the network-shift start message from the STA 102 (F1111) and sends back “Ack” to the STA 102 (F1112). When the STA 102 receives “Ack” from the STA 103, it sends back “Ack” to the STA 101 (F1113).

Upon receiving “Ack” from the STA 102, the STA 101 cuts off the connection with the AP 104 (F1115) and associates with the STA 102 operating in the AP mode in a time sharing manner (F1116). Further, the STA 101 performs the data communication with the STA 102 upon receiving a message instructing start of the communication from the STA 102, and stops the data communication with the STA 102 upon receiving a message instructing stop of the communication (F1120, F1121 and F1122).

Because the group setting request is denied by the communication partner, i.e., the STA 103, the STA 102 executes the AP mode in a time sharing manner. At this time, a switching time between the terminal mode and the AP mode is decided so that the connection with the AP 104 is maintained in the terminal mode. In other words, the STA 102 maintains the connection with the AP 104 by the time sharing operation in the terminal mode while it constructs the network with the identifier BSS2 by the time sharing operation in the AP mode.

Accordingly, during a certain period, the STA 102 performs communication with the STA 103 under management of the AP 104 in a state associating with the AP 104 in the terminal mode. During the remaining period, the STA 102 operates in the AP mode to perform communication with the STA 101 which is in association with the STA 102.

Before starting the operation in the AP mode, the STA 102 instructs stop of the communication (F1114) to the STA 103 which has denied the group setting request, thus temporarily stopping the communication with the STA 103 while starting the operation in the AP mode. When the STA 102 accepts the association from the STA 101 during the operation in the AP mode (F1116), the STA 102 is connected to the STA 101.

After starting the operation in the terminal mode, the STA 102 operating in the time sharing manner instructs start of the communication (F1117) to the STA 103 and performs the data communication (F1118). Also, before subsequent switching to the AP mode, the STA 102 instructs stop of the communication (F1119) to the STA 103, thus temporarily stopping the communication with the STA 103.

When the STA 102 starts the operation in the AP mode, the STA 102 instructs start of the communication (F1120) to the STA 101 and performs the data communication (F1121). Further, before subsequent switching to the terminal mode, the STA 102 instructs stop of the communication (F1122) to the STA 101, thus temporarily stopping the communication with the STA 101. During the time sharing operation, the STA 102 repeats the above-described operation.

When the STA 103 receives the message instructing stop of the communication (F1114) from the STA 102 after transmitting “Ack” (F1112) in response to the network-shift start message from the STA 102, the STA 103 temporarily stops the communication with the STA 102. Also, when the start of the communication (F1117) is instructed to the STA 103 from the STA 102 after the switching to the terminal mode, the STA 103 resumes the data communication (F1118) with the STA 102 which has been stopped so far. Thereafter, when the STA 103 receives the message instructing stop of the communication (F1119) which is transmitted from the STA 102 before the switching to the AP mode, the STA 103 temporarily stops the data communication with the STA 102.

The STA 101 having started the above-described time sharing operation periodically executes the distance determining process (F1123) by the distance determining unit 206.

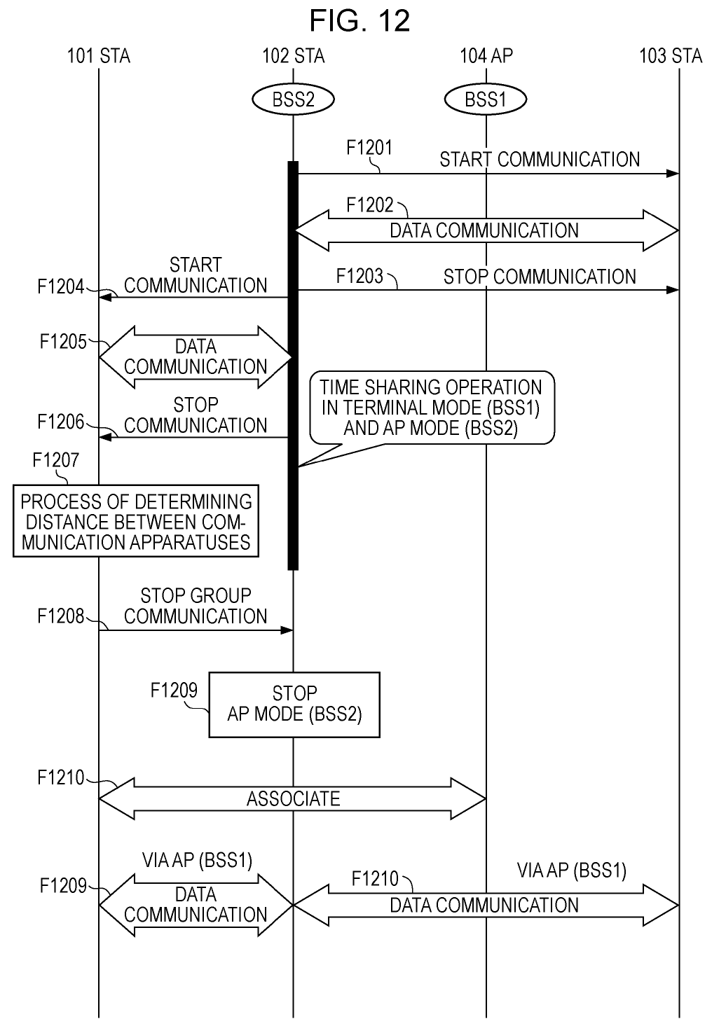

FIG. 12 is a sequence chart executed when, after the processing of FIG. 11, the STA 102 stops the operation in the AP mode and the STA 101 associates in the terminal mode with the AP 104 again.

During the above-described time sharing operation (F1201 to F1206), the STA 101 periodically executes the distance determining process (F1207) by the distance determining unit 206. Based on the result of the distance determining process executed by the distance determining unit 206 of the STA 101, the STA 101 determines whether the operation of the STA 102 in the AP mode is to be stopped to stop the communication based on the group setting.

When the result of the distance determining process indicates that, from the viewpoint of the wireless communication state, the distance between the STA 101 and the AP 104 is shorter than the distance between the STA 101 and the STA 102 for which the group setting has been requested, the communication based on the group setting is determined to be stopped. When the communication based on the group setting is stopped, the STA 101 transmits a message instructing stop of the group communication to the STA 102 (F1208). Thereafter, the STA 101 cuts off the connection with the STA 102 and associates with the AP 104 (F1210).

Upon receiving the message instructing stop of the group communication from the STA 101, the STA 102 stops the time sharing operation in the AP mode and the terminal mode (F1209). Thereafter, since the STA 102 maintains the connection with the AP 104, it performs the communication under control of the AP 104. Thus, the communication with the STA 101 and the STA 103 is performed via the AP 104 (F1209 and F1210). The STA 103 continues the data communication with the STA 102 via the AP 104 (F1210).

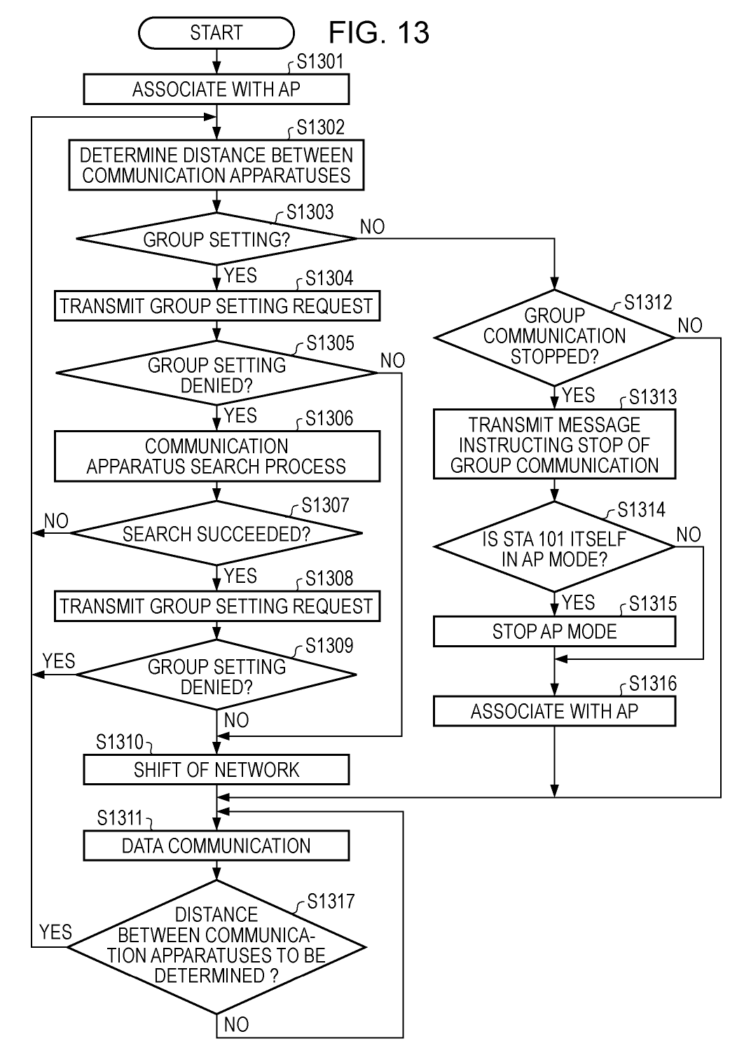

FIG. 13 is a flowchart illustrating the above-described operation of the STA 101.

The STA 101 associates with the AP 104 and is connected to the AP 104 (S1301). The STA 101 having associated with the AP 104 performs, as required, the data communication under management of the AP 104. The STA 101 having associated with the AP 104 executes the process of determining the distance between the communication apparatuses by the distance determining unit 206 (S1302). As described above, the distance determining process is executed by receiving “Beacon” which is periodically transmitted from the AP 104, receiving “Probe Response” which is transmitted from the AP 104, or by intercepting “Probe Request” which is periodically transmitted from another STA.

Based on the result of the distance determining process, the STA 101 determines whether there is some other STA which is located at a shorter distance to the STA 101 than the AP 104 from the viewpoint of the wireless communication state, and whether the group setting is to be executed (S1303). Herein, if there is some other STA which is located at a shorter distance to the STA 101 than the AP 104 from the viewpoint of the wireless communication state, the STA 101 makes determination to execute the group setting.

When the group setting is executed, the STA 101 transmits the group setting request, via the AP 104, to the STA which has been determined to be located at a shorter distance to the STA 101 than the AP 104 from the viewpoint of the wireless communication state (S1304). Upon receiving the group setting response in reply to the group setting request, the STA 101 determines based on the contents of the group setting response whether the group setting request has been accepted or denied (S1305).

If the determination result indicates that the group setting request has been allowed (accepted), the processing flow advances to S1310. If the group setting request is denied, the STA 101 executes the search process by the search processing unit 207 (S1306). The search process can be executed by the search processing unit 207 of the STA 101 itself to search for another STA as described above, or by the search processing unit 207 of the other STA.

When the search process is executed by the other STA, a search request is transmitted to the STA which has been determined by the distance determining unit 206 to be located at a shorter distance to the STA 101 than the AP 104 from the viewpoint of the wireless communication state, thus causing the relevant STA to execute the search process. Then, the STA 101 receives the search result from the STA which has executed the search process. Also, when the STA 101 executes the search process by itself and does not succeed in finding another STA located nearby (i.e., in the case of a search failure), the search process can be executed by the STA which has been determined to be located at a shorter distance to the STA 101 than the AP 104 from the viewpoint of the wireless communication state.

Further, when some other STA located nearby is not found (i.e., in the case of a search failure) as a result of instructing the search process to be executed by the STA which has been determined to be located at a shorter distance to the STA 101 than the AP 104 from the viewpoint of the wireless communication state, the STA 101 can execute the search process by itself. As an alternative, the search processes can be executed in parallel by both the STA 101 itself and the STA which has been determined to be located at a shorter distance to the STA 101 than the AP 104 from the viewpoint of the wireless communication state, and to utilize the results of the search processes executed by both the STAs.

In the search process, as described above, whether some other STA is located nearby or not is determined by intercepting “Probe Request” periodically transmitted from the STA which is in association with the AP 104. Based on the result of the search process, it is determined whether the STA located nearby has been found and the search process has succeeded (S1307).

If the STA located nearby cannot be found, the search process is determined to have failed and the processing flow returns to S1302. If the search process has succeeded, the STA 101 transmits, via the AP 104, the group setting request to the STA which has been found in the search process (S1308). Upon receiving the group setting response in reply to the group setting request, the STA 101 determines based on the contents of the group setting response whether the group setting request has been accepted or denied (S1309).

If the group setting response from the STA found in the search process indicates that the group setting request has been denied, the processing flow returns to S1302. If the group setting response from the STA found in the search process indicates that the group setting request has been accepted, the processing flow advances to S1310.

In S1310, a network shift process based on the group setting is executed. In the network shift process described above with reference to FIGS. 4, 6 and 7, the STA 101 switches over to the AP mode and forms a network while it serves as the access point. In the network shift process described above with reference to FIGS. 9 and 11, the STA 101 notifies start of the network shift to the STA 102, and the STA 102 forms a network while it serves as the access point.

When the network shift process is completed, the data communication is performed as required (S1311). Next, the STA 101 determines whether the process of determining the distance between the communication apparatuses in a periodical manner is to be executed (S1317). If the distance determining process is executed, the processing flow returns to S1302. If the distance determining process is not executed, the data communication is continued as required (S1311).

If it is determined in S1303 that the group setting is not performed, the STA 101 determines whether the communication based on the group setting is to be stopped. When the communication based on the group setting is not performed, the data communication is continued as required because of no necessity of stopping the communication based on the group setting (S1311).

Further, if the result of the distance determining process indicates that, from the viewpoint of the wireless communication state, the distance up to the STA to which the group setting request has been transmitted in S1304 or S1308 is shorter than the distance up to the AP 104, the STA 101 determines that the communication based on the group setting is not to be stopped (S1312). The data communication is then continued as required (S1311).

If the result of the distance determining process indicates that, from the viewpoint of the wireless communication state, the distance up to the AP 104 is shorter than the distance up to the STA to which the group setting request has been transmitted in S1304 or S1308, the STA 101 determines that the communication based on the group setting is to be stopped. If the communication based on the group setting is to be stopped, the STA 101 transmits the message instructing stop of the group communication to the STA to which the group setting request has been transmitted in S1304 or S1308 (S1313).

After transmitting the message instructing stop of the group communication, the STA 101 determines whether the STA 101 itself operates in the AP mode in the group setting (S1314). If the STA 101 itself operates in the AP mode, the STA 101 stops the operation in the AP mode (S1315) and associates in the terminal mode with the AP 104. If the STA 101 itself does not operate in the AP mode, the STA 101 associates in the terminal mode with the AP 104 (S1316) when it is in a state not associating with the AP 104, or performs the data communication under management of the AP 104 (S1311), as required, when it is in a state associating with the AP 104.

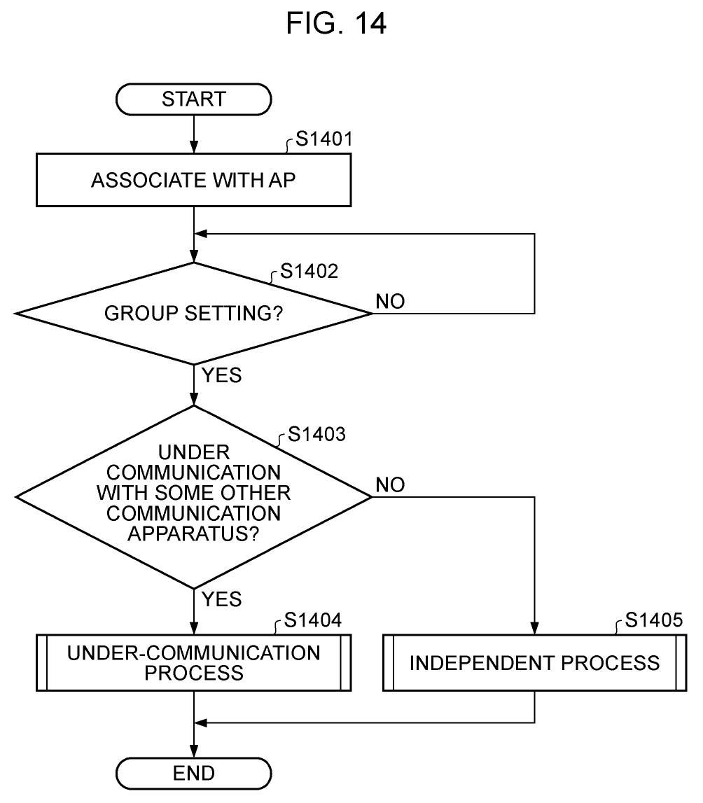

FIG. 14 is a flowchart illustrating the above-described operation of the STA 102. The STA 102 associates with the AP 104 and is connected to the AP 104 (S1401). The STA 102 having associated with the AP 104 performs, as required, the data communication under management of the AP 104. The STA 102 determines whether it has received the group setting request from another STA (S1402). If the STA 102 has not received the group setting request, the STA 102 monitors the group setting request. If the STA 102 has received the group setting request, the STA 102 determines whether it is under communication with some other STA (S1403).

Herein, some other STA means the STA other than the STA which has transmitted the group setting request. If the group setting is performed between the STA having transmitted the group setting request and the STA 102, then the STA 102 may not be able to continue the communication with some other STA any more. To avoid such a problem, the STA 102 executes the above-described determination to change over the process depending on whether the STA 102 is under communication with some other STA.

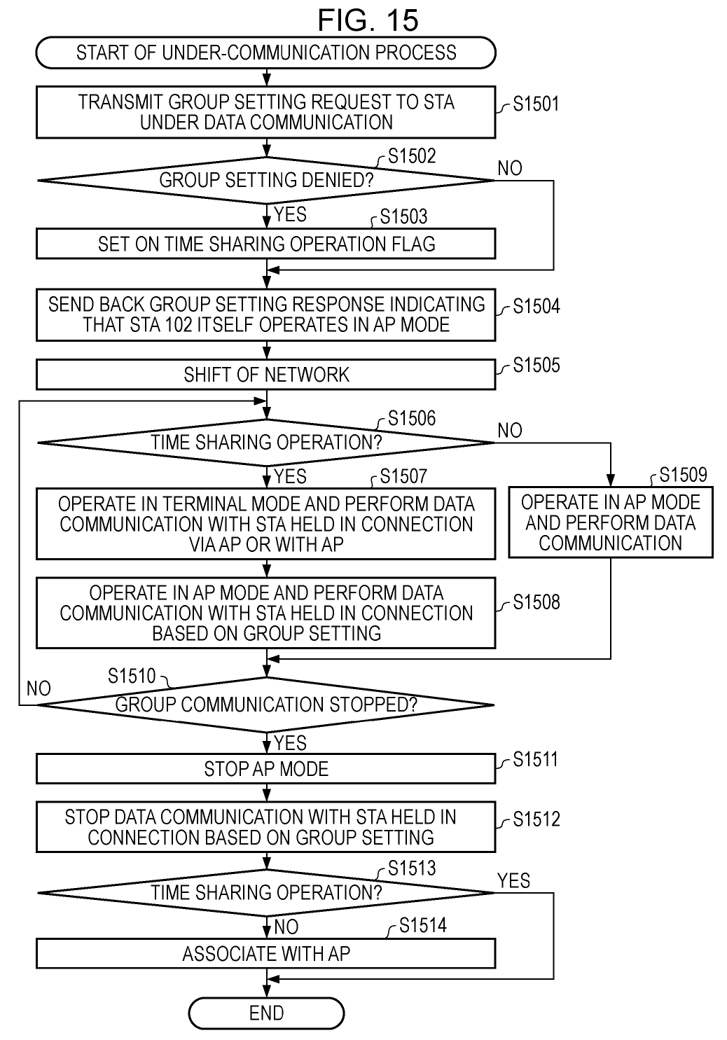

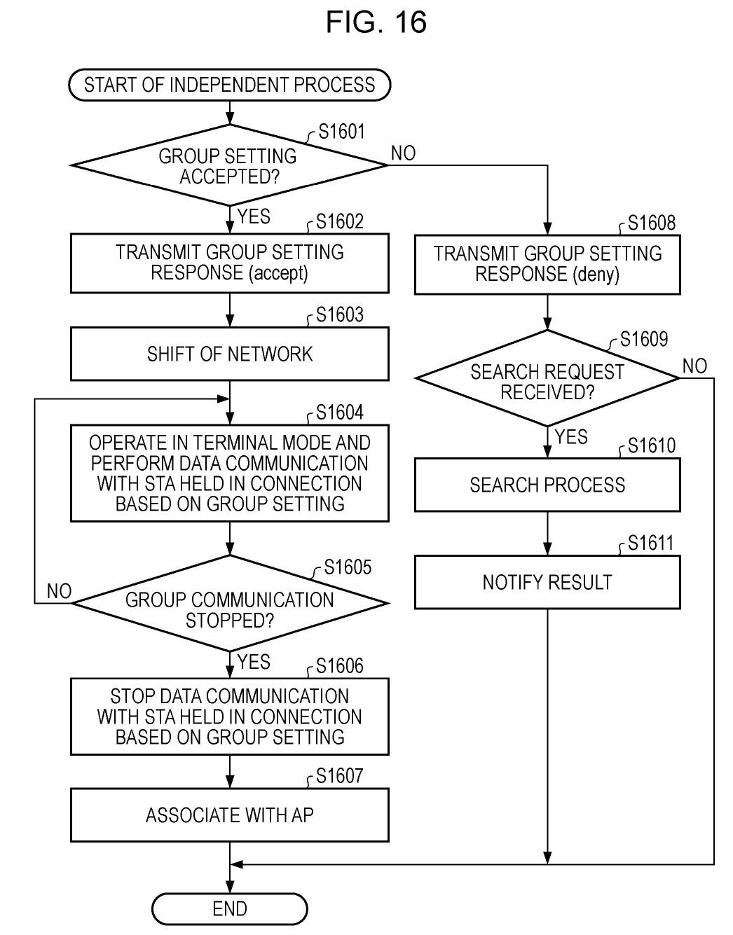

If the determination result of S1403 indicates that the STA 102 is under communication with some other STA, the under-communication process illustrated in FIG. 15 is executed (S1404). If the STA 102 is not under communication with some other STA, the independent process illustrated in FIG. 16 is executed (S1405). In the cases of FIGS. 4, 6 and 7, the STA 102 executes the independent process. In the cases of FIGS. 9 and 11, the STA 102 executes the under-communication process.

FIG. 15 is a flowchart illustrating the under-communication process in the operation of the STA 102.

In the under-communication process, the STA 102 transmits the group setting request to the STA which is the communication counterpart in the data communication (S1501). Upon receiving the group setting response from the STA as the communication partner, the STA 102 determines, based on the contents of the received group setting response, whether the group setting request has been allowed (accepted) or denied (S1502). If the group setting request has been denied, a time sharing operation flag is set on (S1503). If the group setting request has been allowed (accepted), the processing flow advances to S1504.

In S1504, the STA 102 sends back, to the STA as a transmission source of the group setting request, a group setting response representing that the STA 102 itself operates in the AP mode. When the STA 102 receives the network-shift start message from the STA to which the group setting response has been sent back, the STA 102 executes the processing of F911, F913 and F915 in FIG. 9 or the processing of F1111, F1113 and F1114 in FIG. 11, thus executing the network shift process as described above (S1505).

The STA 102 determines the setting state of the time sharing operation flag and further determines whether the time sharing operation is to be performed (S1506). If the time sharing operation flag is set on and the time sharing operation is to be performed, the STA 102 performs the time sharing operation in the AP mode and the terminal mode as described above with reference to FIG. 11 (S1507 and S1508). If the time sharing operation flag is not set on and the time sharing operation is not to be performed, the STA 102 operates in the AP mode and performs the data communication with the other relevant STA as required (S1509).

Thereafter, the STA 102 determines whether it has received the message instructing stop of the group communication (S1510). If the STA 102 has received the message instructing stop of the group communication, the STA 102 stops the operation in the AP mode (S1511) and also stops the data communication with the STA which is connected to the STA 102 based on the group setting (S1512).

Further, the STA 102 determines whether the time sharing operation has been performed (S1513). If the time sharing operation has not been performed, the STA 102 associates with the AP 104 to which the STA 102 has been connected before starting the communication based on the group setting, and is connected to the AP 104 again (S1514). If the time sharing operation has been performed (S1513), this means that the STA 102 maintains the state connected to the AP 104. Therefore, the STA 102 continuously maintains the state connected to the AP 104.

If the message instructing stop of the group communication is not received in S1510, the processing flow returns to S1506.

FIG. 16 is a flowchart illustrating the independent process in the operation of the STA 102.

In the independent process, the STA 102 determines whether it accepts the group setting request (S1601). As described above, whether to accept the group setting request or not is determined by providing, on the user interface, a display indicating that the group setting request has been transmitted from another communication apparatus, and by receiving an input made, through the user interface, by the user who has checked the displayed request. As an alternative, the user can previously set whether the group setting request is to be accepted, so that the determination is automatically made depending on the user's setting.

If the STA 102 accepts the group setting request, the STA 102 sends back the group setting response (accept) to the STA as the transmission source of the group setting request (S1602). If the STA 102 denies the group setting request, the STA 102 sends back the group setting response (deny) to the STA as the transmission source of the group setting request (S1608).

When the STA 102 transmits the group setting response (accept) (S1602) and receives the network-shift start message from the STA as the transmission source of the group setting request, the STA 102 executes the network shift process (S1603). In the case of FIG. 4, the processing of F408, F410 and F412 is executed. More specifically, the STA 102 cuts off the connection with the AP 104 and associates with the STA 101 operating in the AP mode for connection to the STA 101.

When the shift of the network is completed, the STA 102 performs, as required, the data communication under management of the STA 101 operating in the AP mode (S1604). The STA 102 determines whether it has received the message instructing stop of the group communication (S1605). If the STA 102 has received the message instructing stop of the group communication, the STA 102 stops the data communication with the STA (i.e., the STA 101) which is connected to the STA 102 based on the group setting (S1606). Thereafter, the STA 102 associates with the AP 104 and is connected to the AP 104 (S1607).

Further, after sending back the group setting response (deny) (S1608), the STA 102 determines whether it has received the search request (S1609). If the STA 102 has not received the search request, the processing is brought to an end. If the STA 102 has received the search request, the STA 102 executes the above-described search process (S1610) and sends back, as a search response, the search result to the transmission source of the search request (S1611).

While the above exemplary embodiment is described in connection with the IEEE 802.11 standards, it is not limited to this communication method. Any communication method, e.g., UWB (Ultra Wide Band), that would enable practice of the present invention is applicable.

As described above, depending on the positional relationship with respect to the nearby-located device (AP or STA), the STA other than the AP operates in the AP mode and constructs a new network, thus ensuring efficient communication. Also, since the STA other than the AP operates in the AP mode and constructs a new network, the advantages with the infrastructure mode can be utilized while suppressing various problems occurred when the ad-hoc mode is employed.

For example, communication can be performed with even a STA, which is not adapted for the ad-hoc mode, through the new network. The problem of mutual connection ability caused in the ad-hoc mode can be avoided. Power saving can be realized under management with the access point function. Further, security management with the access point function can be performed and a security level can be improved in comparison with that in the ad-hoc mode.

In addition, since the network configuration can be modified depending on change of the communication state (positional relationship), the communication can be performed in a state of better radio wave environment.

Thus, since the communication apparatus operates as a managing device and forms a new network depending on change of the communication environment, the communication can be performed with high efficiency.

The features of the present invention can also be achieved by supplying a storage medium, which stores program code of software for implementing the above-described embodiment, to a system or an apparatus, and by causing a computer in the system or the apparatus to read and execute the program code stored in the storage medium. In that case, the program code read out of the storage medium serves in itself to implement the above-described embodiment, and therefore the storage medium storing the program code constitutes the present invention.

Storage media for providing the program code can be, e.g., a floppy disk, a hard disk, an optical disk, a magneto-optical disk, a CD-ROM, a CD-R, a magnetic tape, a nonvolatile memory card, a ROM, and a DVD.

Also, the present invention involves the case where, for example, an operating system (OS) running in the computer executes a part or the whole of actual processing in accordance with commands from the program code, thereby implementing the above-described embodiment.

Further, the present invention involves the case where the program code is written in a memory provided in a function extension unit which is inserted in the computer, and a control unit incorporated in the function extension unit executes a part or the whole of the actual processing in accordance with commands from the program code, thereby implementing the above-described embodiment.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2006-208498 filed Jul. 31, 2006, which is hereby incorporated by reference herein in its entirety.

What is claimed is:

1. A communication apparatus comprising:
a determining device configured to determine a distance between the communication apparatus and a first managing device in a first network; and
a forming device configured to, based on a result of the determining device, form a second network in which either the communication apparatus or another communication apparatus functions as a second managing device.

2. The communication apparatus according to claim 1, wherein the determining device determines a distance between the communication apparatus and the another communication apparatus, and
wherein the forming device forms the second network depending on the distance between the communication apparatus and the first managing device and the distance between the communication apparatus and the another communication apparatus.

3. The communication apparatus according to claim 1, further comprising:
a requesting device configured to request the another communication apparatus to set the second network; and
an identifying device configured to identify a response from the another communication apparatus in reply to the request from the requesting device,
wherein the forming device forms, in accordance with a result of the identifying device, the second network in which the communication apparatus functions as the second managing device.

4. The communication apparatus according to claim 1, further comprising:
a cutting-off device configured to cut off connection with the first managing device when the forming device forms the second network.

5. The communication apparatus according to claim 1, further comprising:
a participating device configured to effectuate participation into the first network managed by the first managing device in accordance with a result of the determining device.

6. The communication apparatus according to claim 5, wherein the forming device terminates the formation of the second network when the participation into the first network is effectuated by the participating device.

7. The communication apparatus according to claim 3, further comprising:
a searching device configured to search for a communication apparatus different from the another communication apparatus based on a result of the identifying device,
wherein the requesting device requests a communication apparatus, been found by the searching device, to set the second network.

8. The communication apparatus according to claim 7, wherein the searching device requests the another communication apparatus to search for a different communication apparatus than the another communication apparatus.

9. The communication apparatus according to claim 3, wherein the forming device effectuates participation, in accordance with a result of the identifying device, into the second network in which the another communication apparatus functions as the second managing device.

10. The communication apparatus according to claim 1, wherein the determining device determines the distance by using at least one of a radio wave intensity, an error rate of a received signal, or an attenuation rate of the received signal.

11. A communication apparatus comprising:
a requesting device configured to, upon receiving a network setting request from another communication apparatus while the communication apparatus participates in a first network managed by a first managing device, request a communication partner to set a network; and
a forming device configured to, based on a response from the communication partner in reply to the request from the requesting device, effectuate a function as a second managing device and form a second network while continuing participation in the first network.

12. The communication apparatus according to claim 11, wherein the forming device determines, based on the response from the communication partner in reply to the request from the requesting device, whether to form the second network while continuing participation in the first network or to form the second network after terminating participation in the first network.

13. The communication apparatus according to claim 11, wherein the forming device switches from functioning as an apparatus managed by the first managing device to functioning as the second managing device.

14. The communication apparatus according to claim 11, wherein if the communication apparatus is not communicating with a communication apparatus different from the another communication apparatus when receiving the setting request, the forming device effectuates participation into a network formed by the another communication apparatus serving as a managing device.

15. A method of forming a second network separate from a first network formed by a first managing device, the method comprising:
determining a distance between a communication apparatus and the first managing device in the first network; and
forming, based on determining a distance between the communication apparatus and a first managing device, a second network in which either the communication apparatus or another communication apparatus functions as a second managing device.

16. A computer-readable storage medium storing computer-executable process steps, the computer-executable process steps causing a computer to execute the method of claim 15.

17. A method of controlling a communication apparatus for forming a second network separate from a first network formed by a first managing device, the method comprising:
requesting, upon receipt of a network setting request from another communication apparatus while the communication apparatus participates in the first network, a communication partner to set a network; and
effectuating, based on a response from the communication partner in reply to a request for the communication partner to set a network, a function as a second managing device and forming a second network while continuing participation in the first network.

18. A computer-readable storage medium storing computer-executable process steps, the computer-executable process steps causing a computer to execute the method of claim 17.
